(19) United States
(12) Patent Application Publication
(10) Pub. No.: US 2023/0415704 A1
(43) Pub. Date: Dec. 28, 2023

(54) SENSOR CLEANING DEVICE

(71) Applicants: Hyundai Motor Company, Seoul (KR); Kia Corporation, Seoul (KR)

(72) Inventors: Ki Hong Lee, Seoul (KR); Nak Kyoung Kong, Seongnam (KR); Jong Min Park, Seoul (KR)

(21) Appl. No.: 18/078,937

(22) Filed: Dec. 10, 2022

(30) Foreign Application Priority Data
Jun. 27, 2022 (KR) 10-2022-0077935

(51) Int. Cl. B60S 1/56; B08B 1/00; B60S 1/26; B60S 1/08

(52) U.S. Cl. CPC B60S 1/566; B08B 1/006; B60S 1/26; B60S 1/0803; B60S 1/0818

(57) ABSTRACT

Provided is a sensor cleaning device. The sensor cleaning device is configured to clean a sensor mounted on a vehicle. The sensor cleaning device includes a housing having an opening, a protection member movably disposed with respect to the opening, and a cleaning member mounted around the opening and disposed in close contact with the protection member. Also provided is a method of controlling a sensor cleaning device. The method is performed by a controller configured to control an operation of a motor and a nozzle of the sensor cleaning device. The method includes 1) detecting a first contamination of a protection member configured to protect an environmental sensor and disposed to be movable by the motor; 2) spraying a washer fluid to the protection member; 3) and driving the motor so that the protection member is wiped by a cleaning member disposed in contact with the protection member.

### CROSS REFERENCE TO RELATED APPLICATION

The present application claims under 35 U.S.C. § 119(a) the benefit of Korean Patent Application No. 10-2022-0077935, filed Jun. 27, 2022, the entire contents of which is incorporated herein for all purposes by this reference.

### TECHNICAL FIELD

The present disclosure relates to a sensor cleaning device and, more particularly, to a sensor cleaning device for cleaning a sensor mounted on a vehicle.

### BACKGROUND

Recently, a driver assistance system that assists a driver of a vehicle is installed in a vehicle in order to secure safe driving in various driving situations. In addition to the driver assistance system, research and development on autonomous vehicles in which the vehicle can drive itself without driver intervention is being actively conducted.

For such driver assistance systems or autonomous vehicles, various types of environmental sensors capable of sensing the environment around the vehicle in various ways are required. As an environmental sensor installed in a vehicle, a radar, a LiDAR, a camera, and the like may be used.

Since these environmental sensors are mounted on the outside of the vehicle, the sensing area may be easily dirty by foreign substances, such as dust, rain, snow, etc. depending on driving conditions, such as climate, road conditions, and surrounding environments. Since the performance of each sensor may be deteriorated when each sensor is contaminated, these sensors should be kept clean at a certain level or more in order to maintain the performance of the sensor. Accordingly, a contamination detection device to detect contamination of these sensors and a sensor cleaning system capable of cleaning the sensor when a sensing part is contaminated based on the detection are provided in the vehicle.

### SUMMARY

The present disclosure is intended to solve the above problems, and to provide a sensor cleaning device for protecting a sensor mounted on a vehicle and exposed to the outdoors, and always keeping the sensor clean.

The objectives of the present disclosure are not limited to those mentioned above, and other objects not mentioned are clearly understood by those skilled in the related art to which the present disclosure belongs from following the description (hereinafter referred to as ‘those skilled in the related art’).

In order to achieve the objectives of the present disclosure as described above and perform the characteristic functions of the present disclosure to be described later, the features of the present disclosure are as follows.

In one aspect, a sensor cleaning device is provide that comprises: a housing having an opening; a protection member movably disposed with respect to the opening; and a cleaning member mounted around the opening and disposed in contact with the protection member.

According to an exemplary embodiment of the present disclosure, a sensor cleaning device includes: a housing having an opening; a transparent protection member movably disposed with respect to the opening; and a cleaning member mounted around the opening and disposed in contact with the protection member.

According to another embodiment of the present disclosure, there is provided a method of controlling the sensor cleaning device, the method being configured to perform the following steps under the control of a controller that is configured to control the operation of a motor and a nozzle of the sensor cleaning device, the method including: detecting a first contamination of the protection member configured to protect an environmental sensor and disposed to be movable by the motor; spraying a washer fluid to the protection member; and driving the motor so that the protection member is wiped by the cleaning member disposed in contact with the protection member.

According to the present disclosure, there is provided the sensor cleaning device for protecting and always keeping the sensor installed in a vehicle and exposed to the outdoors clean.

As discussed, the method and system suitably include use of a controller or processer.

In another embodiment, vehicles are provided that comprise an apparatus as disclosed herein.

Effects of the present disclosure are not limited to those described above, and other effects not mentioned will be clearly recognized by those skilled in the art from the following description.

### BRIEF DESCRIPTION OF THE DRAWINGS

FIG. 1 is a view showing the arrangement of an exemplary environmental sensor provided in a vehicle;

FIG. 2 is a view showing a sensor cleaning device according to an exemplary embodiment of the present disclosure;

FIG. 3 is a view showing a plan view of the sensor cleaning device;

FIG. 4 is an outer side view of the hosing of the sensor cleaning device;

FIG. 5 is an inner side view of the housing of the sensor cleaning device;

FIG. 6 is a view showing a state in which a part of the housing of the sensor cleaning device is omitted;

FIG. 7 is a view showing the sensor cleaning device of FIG. 6 viewed from the inside;

FIG. 8 is a view showing a state in which the sensor cleaning device of FIG. 7 is moved;

FIG. 9 is a view showing a control configuration diagram of the sensor cleaning device according to an exemplary embodiment of the present disclosure;

FIG. 10 is a view showing an outer side view of the housing of the sensor cleaning device according to an exemplary embodiment of the present disclosure;

FIG. 11 is a view showing an inner side view of the housing of the sensor cleaning device; and

FIGS. 12 and 13 are views showing respectively an outer side view and an inner side view with the housing removed.

### DETAILED DESCRIPTION

Specific structural or functional descriptions presented in the embodiments of the present disclosure are only exemplified for the purpose of describing embodiments according to the concept of the present disclosure, and the embodiments according to the concept of the present disclosure may be implemented in various forms. In addition, it should not be construed as being limited to the embodiments described herein, and should be understood to include all modifications, equivalents, and substitutes included in the spirit and scope of the present disclosure.

Meanwhile, in the present disclosure, terms such as first and/or second may be used to describe various components, but the components are not limited to the above terms. The above terms are used only for the purpose of distinguishing one component from other components, for example, within the scope not departing from the scope of the rights according to the concept of the present disclosure, the first component may be named as the second component. Similarly, the second component may also be named as the first component.

When a component is referred to as being “connected” or “connected” to another component, it should be understood that it may be directly connected or connected to the other component, but other components may exist in between. On the other hand, when it is mentioned that a certain element is “directly connected” or “directly contacted” with another element, it should be understood that no other element is present in between. Other expressions for describing the relationship between elements, that is, expressions such as “between” and “immediately between” or “adjacent to” and “directly adjacent to,” should be interpreted similarly.

Like reference numbers refer to like elements throughout. On the other hand, the terms used herein are for the purpose of describing the embodiments and are not intended to limit the present disclosure. In this description, the singular form also includes the plural form unless otherwise specified in the phrase. As used herein, “comprises” and/or “comprising” means that a referenced component, step, operation and/or element is the presence of one or more other components, steps, operations and/or elements, or addition is not excluded.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, preferred embodiments of the present disclosure will be described in detail with reference to the accompanying drawings.

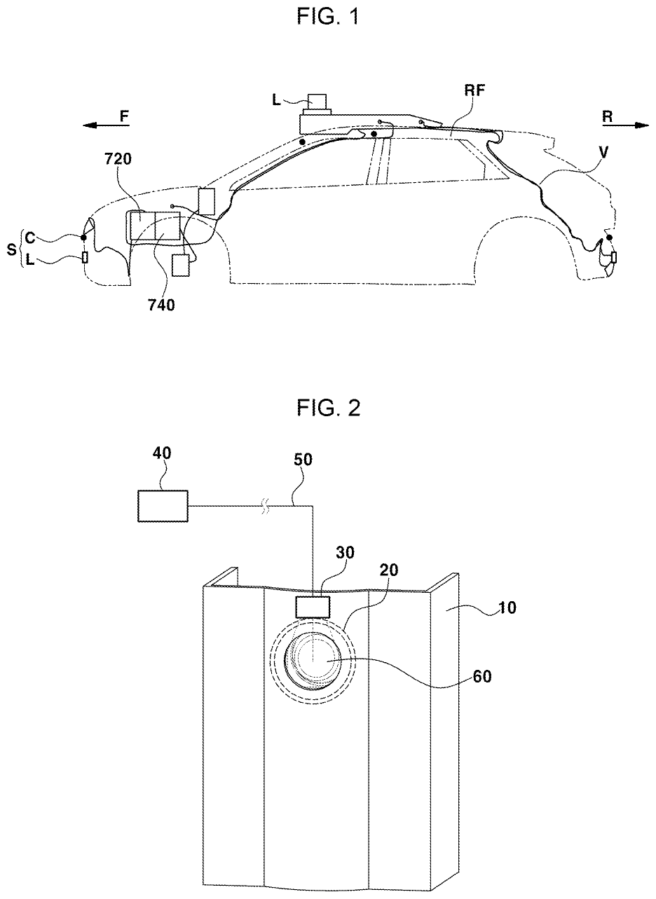

As described above, various types of environmental sensors for sensing the surrounding environment are mounted on an autonomous vehicle or a vehicle equipped with a driver assistance system. As a non-limited example, the environmental sensor includes a lidar, a radar, a camera and the like, and the environmental sensor may be disposed on a front part, a rear part, a roof, etc. of a vehicle. FIG. 1 shows an exemplary arrangement state of the lidar sensor L and the camera sensor C among the environmental sensors S. The lidar sensor L may be disposed on the roof RF, the front F, the rear R, etc., of the vehicle V, respectively, and one and more camera sensors C may be disposed in the front F, the rear R, the roof RF, the side, etc. of the vehicle, respectively. In particular, as the level of autonomous driving increases, the number of environmental sensors S mounted on the vehicle V is increasing.

Since most vehicles stay outside and because the vehicle is driven in various condition, environmental sensors mounted on the outside of the vehicle may be contaminated not only by rainfall but also by foreign substances, such as dust and insects. Accordingly, a sensor cleaning system is provided in the vehicle to clean the dirty environmental sensor. The cleaning of the environmental sensor may be performed by using a high-pressure washer fluid or by spraying high-pressure air or a combination thereof. Specifically, the sensor cleaning system of the vehicle detects whether the environmental sensor is contaminated. The cleaning may be performed by spraying the high-pressure washer fluid from a washer fluid supply device 720 to the dirty environmental sensor and/or by spraying the compressed air from an air cleaning device 740, comprising an air tank and compressor.

During the cleaning using washer fluid currently used, a washer fluid of a certain pressure (high pressure) is sprayed to the environmental sensor. At this time, the entire vehicle may be contaminated with the washer fluid, such as the washer fluid splashing around. In addition, after the washer fluid is sprayed, drops of the washer fluid may remain on the surface of the environmental sensor, which may reduce the accuracy of sensing information provided to the autonomous driving system, which in turn may result in degradation of the performance of the autonomous driving system. Accordingly, it is needed to add a separate air cleaning device for removing these residual droplets. In addition, since the sprayed washer fluid drops may be frozen in winter, additional improvement measures may be required. The additional mounting of the air cleaning device and the high-pressure washer fluid supply device occupies a lot of space in the vehicle and increases the weight of the vehicle, causing a decrease in the cruising range. Also, there are difficulties in terms of packaging.

Accordingly, the present disclosure may intend to provide a sensor cleaning device capable of reducing the consumption of a washer fluid used for sensor cleaning and omitting an air cleaning device to secure space and reduce weight.

In addition, the camera sensor among environmental sensors detects a wide-angle external image, and the autonomous driving system is configured to analyze the image sensed by the camera sensor. If the surface of the camera sensor is contaminated, shapes of outside of the vehicle may be distorted, making accurate image analysis difficult. Therefore, it is very important to keep the surface of the camera sensor clean so that the camera sensor may be able to sense shapes of outside of the vehicle with high clarity and provide an image thereof.

Accordingly, the present disclosure may intend to provide the sensor cleaning device keeping the surface of the sensor, particularly, the camera sensor, clean for stable performance of an autonomous driving system.

To this end, the sensor cleaning device according to the present disclosure may be able to keep the environmental sensor clean by having a separate protection member additionally disposed on the environmental sensor and cleaning it.

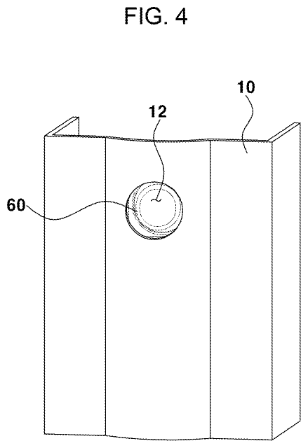

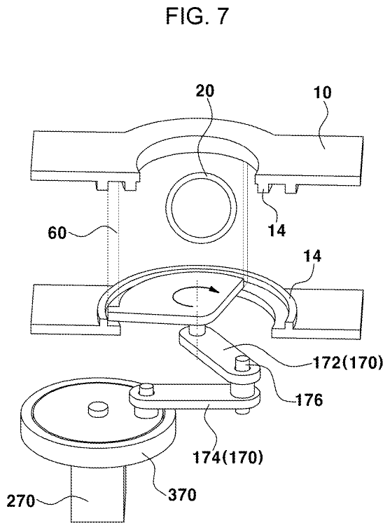

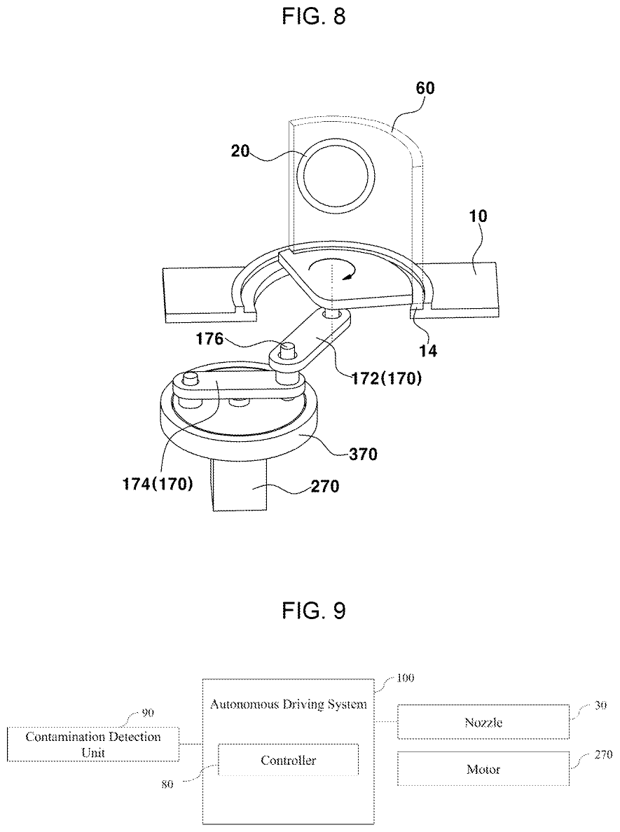

A sensor cleaning device according to an exemplary embodiment of the present disclosure is described with reference to FIGS. 2 to 8.

The sensor cleaning device includes a housing 10. The housing 10 maybe assembled to a vehicle V as a separate part or may be integrally formed with the body of the vehicle V. The housing 10 may be mounted on the outer surface of the vehicle V to be configured to cover an environmental sensor S from the outside. Herein, the environmental sensor S may be a camera sensor C but may be also applied to other environmental sensors.

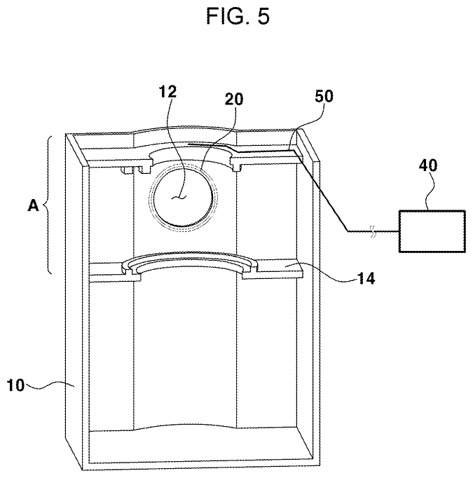

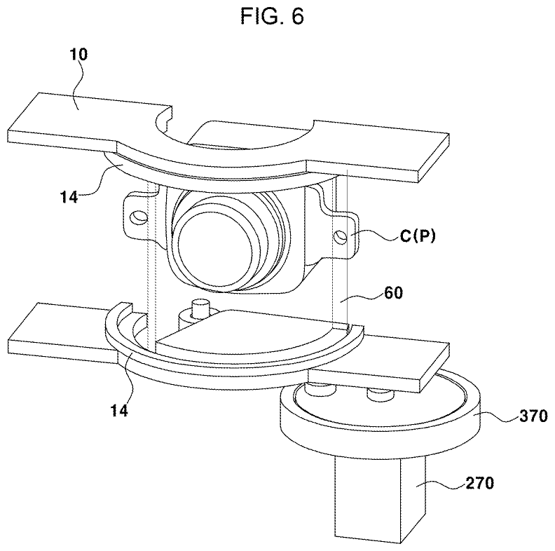

As it is well shown in FIG. 5, the housing 10 may be provided with an opening 12. The environmental sensor S located inside the housing 10 may be disposed to face an outside of the vehicle V through the opening 12 and may be configured to sense the outside of the vehicle.

In addition, a cleaning member 20 is disposed in the housing 10. In particular, the cleaning member 20 may be disposed around the opening 12. The cleaning member 20 is mounted on the housing 10 and is located between the housing 10 and the environmental sensor S. As a non-limiting example, the cleaning member 20 may be formed of rubber, silicone, sponge, or the like. As a non-limiting example, the cleaning member 20 may be formed in a ring shape. However, the cleaning member 20 may be formed in various shapes, such as triangular, polygonal, and oval, in addition to the circular ring shape. Preferably, the cleaning member 20 may be formed to have a shape corresponding to the circumferential shape of the opening 12.

As it is well shown in FIGS. 2 and 5, the housing 10 may be provided with a nozzle 30. The nozzle 30 may receive a washer fluid from a washer fluid reservoir 40 through a supply hose 50 and may be disposed in the housing 10 to spray the washer fluid towards the opening 12. In particular, the washer fluid sprayed through the nozzle 30 may be sprayed through a low pressure injection method, not a conventional high pressure injection method. In case of the conventional high pressure injection method, there was a case of contaminating entire vehicle by the washer fluid or splashing the washer fluid around the environmental sensor S. According to the present disclosure, a low pressure injection method is possible, thereby preventing such cases. In particular, by wiping with the cleaning member 20, a pressure used in the conventional high pressure injection method may be reduced about 25%, and it allows a size of the washer fluid reservoir 40 to be reduced about 25%.

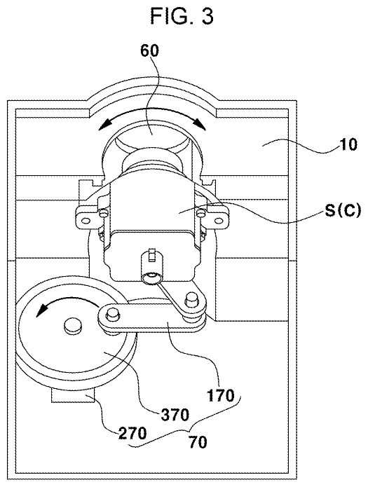

As it is shown in FIGS. 2 and 3, a protection member 60 may be disposed inside the housing 10. The protection member 60 may be made of a transparent material. For example, protection member may be made of a material that can be visually (naked eye) transparent, e.g. at least 40, 50, 60, 70, or 80 percent transmission of visible light. In certain aspects, the protection member may be a plastic or glass material, and can be a film material (including a flexible film) or a rigid or flexible plate member, or other configuration. Specifically, the protection member 60 is disposed to cover the opening 12 of the housing 10, and the protection member 60 is disposed between the housing 10 and the environmental sensor S. That is, the protection member 60 is disposed inside the housing 10 and is located inside the housing 10 to be in close contact with the cleaning member 20. That is, from the outside of the vehicle, the housing 10, the cleaning member 20, the protection member 60, and the environmental sensor S may be disposed in this order. The environmental sensor S located inside the housing 10 is protected by the protection member 60, and only the protection member 60 is contaminated.

The protection member 60 may be movably supported on the housing 10. To this end, according to an exemplary embodiment of the present disclosure, a guide 14 is provided on the housing 10. In one embodiment, the guide 14 projects towards the inner direction of the housing 10. The guide 14 supports the protection member 60 so that the protection member 60 moves with respect to the housing 10. In an exemplary embodiment, two guides 14 may be provided on the inner surface of the housing 10 to face each other. In an exemplary embodiment, the protection member 60 is configured in a curved surface or arc, and the guide 14 is configured to have a curved surface or arc shape, like the shape of the protection member 60. The protection member 60 may be formed to be smaller than the length of the guide 14 to be movable along the entire arc-shaped guide 14. For example, when the arc-shaped guide 14 extends at an angle of about 180°, the protection member 60 may be rotating in a range of about 60° to have a size that can cover all of the about 180°.

As it is shown in FIGS. 6 to 8, a rotation mechanism 70 may provide a moving force to the protection member 60. According to an exemplary embodiment of the present disclosure, the rotation mechanism 70 includes a link 170 and a motor 270.

The link 170 rotatably connects the protection member 60 to the motor 270. The link 170 may be integrally formed with the protection member 60. In an exemplary embodiment, the link 170 may be coupled directly to a rotation axis of the motor 270. In an exemplary embodiment, a rotation gear 370 may be mounted on the rotation axis of the motor 270, and a link 170 may connect the protection member 60 to the rotation gear 370 to move with the rotation of the rotation gear 370.

In an exemplary embodiment, the link 170 may include two or more links. Two or more links 170 may be provided in consideration of a mountable position of the motor 270 in the vehicle V, a moving radius of the link 170, and the like. Specifically, the two links 170 include a protection member-side link 172 and a gear-side link 174. The proximal end of the protection member-side link 172 close to the protection member 60 is coupled to the protection member 60, and a pin member 176 is coupled to the distal end thereof. The proximal end of the protection member-side link 172 is secured to the protection member 60, and the distal end of the protection member-side link 172 is rotatably coupled with the pin member 176 as the center. The gear-side link 174 is also rotatably coupled to the pin member 176. The proximal end of the gear-side link 174 close to the rotation gear 370 is secured to the rotation gear 370, and the distal end of the gear-side link 174 is rotatably coupled to the pin member 176. As a non-limiting example, the proximal end of the gear-side link 174 may be mounted to the rotation gear 370 at an eccentric position from the rotation axis of the motor 270.

Referring to FIG. 9, the sensor cleaning device according to the present disclosure may further include a controller 80. A controller 80 is configured to control the operation of the nozzle 30 and the motor 270. The controller 80 may be a separate controller configured to communicate with an autonomous driving system 100 or may be integrated into the controller of the autonomous driving system 100.

The operation of the sensor cleaning device according to the present disclosure is as follows.

A contamination detection unit 90 capable of determining the contamination level of the protection member 60 maybe provided around the housing 10 or in the housing 10. Since the detection of contamination of the protection member 60 by the contamination detection unit 90 may be performed by a known method, such as using light, the description thereof will be omitted.

The contamination detection unit 90 may be configured to communicate with the autonomous driving system 100. When the contamination detection unit 90 detects contamination of the protection member 60, the contamination detection unit 90 notifies the autonomous driving system 100.

Upon receiving the information of contamination from the contamination detection unit 90, the autonomous driving system 100 or the controller 80 has the nozzle 30 may spray the washer fluid to the protection member 60 and instruct the motor 270 to be driven. The protection member 60 moving one-way or reciprocating by the driving of the motor 270 is cleaned by the cleaning member 20 with the sprayed washer fluid. The wiped portion of the protection member 60 enters the housing 10, and the portion of the protection member 60 without contamination that was inside the housing 10 before the movement of the protection member 60 overlaps the opening 12. Whenever the opening 12 and the overlapped portion of the protection member 60 are contaminated, the washer fluid is sprayed and the protection member 60 is rotated in parallel so that the protection member 60 is always kept clean.

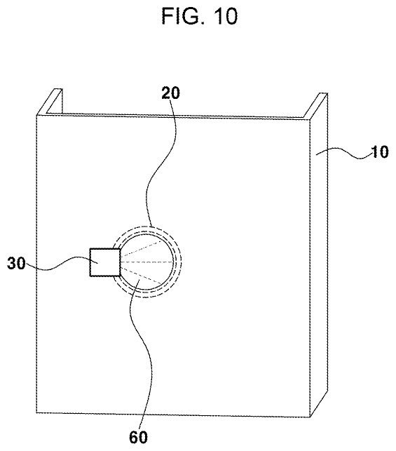

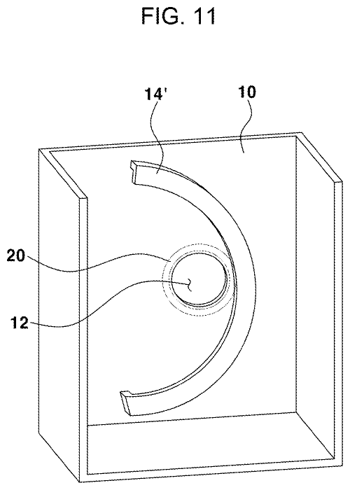

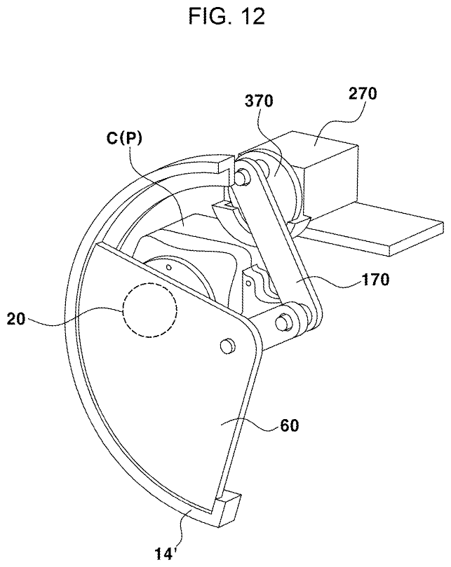

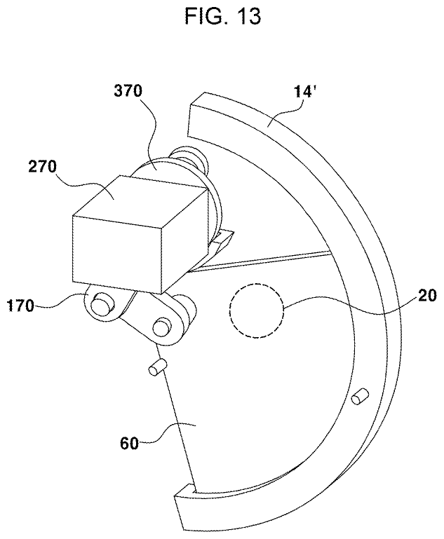

Referring to FIGS. 10 to 13, according to some embodiments of the present disclosure, the protection member 60 of the sensor cleaning device may be configured to rotate about an axis of horizontal direction. In the described embodiment above, the sensor cleaning device or the protection member 60 may be configured to rotate about an axis in a vertical direction. In the present embodiment, a guide 14′ may not be formed integrally with the housing 10 and may be attached separately. However, the guide 14′ being integrally formed with the housing 10 is also possible.

The sensor cleaning device according to the present disclosure may keep the environmental sensor clean even in weather conditions such as rain or heavy snow so that the vehicle can maintain autonomous driving performance.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A sensor cleaning device comprising:
a housing including an opening;
a protection member movably disposed with respect to the opening; and
a cleaning member mounted around the opening and disposed in contact with the protection member.

2. The sensor cleaning device of claim 1 wherein the protection member is a transparent member.

3. The sensor cleaning device of claim 1, further comprising:
a rotation mechanism for moving the protection member, the rotation mechanism comprising:
a link connected to the protection member; and
a motor configured to provide a rotational force to the link.

4. The sensor cleaning device of claim 3, further comprising:
a rotation gear configured to connect the motor with the link.

5. The sensor cleaning device of claim 4, wherein the link comprises a protection member-side link and a gear-side link, and
wherein a distal end of the protection member-side link and a distal end of the gear-side link are rotatably coupled to each other by a pin member.

6. The sensor cleaning device of claim 5, wherein a proximal end of the protection member-side link is secured to the protection member, and a proximal end of the gear-side link is secured to the rotation gear.

7. The sensor cleaning device of claim 5, wherein the protection member-side link and the protection member are integrally formed.

8. The sensor cleaning device of claim 5, wherein a proximal end of the gear-side link is coupled to an eccentric position with respect to a center of the rotation gear.

9. The sensor cleaning device of claim 3, wherein the housing is provided with a guide for guiding a movement of the protection member.

10. The sensor cleaning device of claim 9, wherein the guide is configured to guide the protection member to move in left and right directions with respect to the opening.

11. The sensor cleaning device of claim 9, wherein the guide is configured to guide the protection member to move vertically with respect to the opening.

12. The sensor cleaning device of claim 1, further comprising:
a nozzle mounted on the housing to spray a washer fluid to the protection member.

13. The sensor cleaning device of claim 12, wherein the washer fluid is sprayed onto a surface of the protection member in contact with the cleaning member.

14. The sensor cleaning device of claim 12, further comprising:
a washer fluid reservoir configured to store the washer fluid and supply the washer fluid to the nozzle; and
a washer fluid supply tube configured to connect the washer fluid reservoir with the nozzle.

15. The sensor cleaning device of claim 1, further comprising:
a nozzle mounted on the housing to spray the washer fluid to the protection member,
a rotation mechanism for moving the protection member; and
a controller configured to operate the nozzle and the rotation mechanism at a preset timing.

16. The sensor cleaning device of claim 15, further comprising:
i) a contamination detection unit configured to detect contamination of the protection member and transmit a detection result to the controller, and/or
ii) an environmental sensor configured to sense a surrounding environment and disposed inside the protection member

17. The sensor cleaning device of claim 16, wherein the environmental sensor is a camera sensor.

18. The sensor cleaning device of claim 1, wherein the sensor cleaning device is provided in a vehicle.

19. A method of controlling a sensor cleaning device, the method being performed by a controller configured to control an operation of a motor and a nozzle of the sensor cleaning device, the method comprising:
detecting a first contamination of a protection member configured to protect an environmental sensor and disposed to be movable by the motor;
spraying a washer fluid to the protection member; and
driving the motor so that the protection member is wiped by a cleaning member disposed in contact with the protection member.

20. The method of claim 19, further comprising:
detecting a second contamination of the protection member under the control of the controller;
spraying the washer fluid to the protection member under the control of the controller; and
driving the motor to move the protection member under the control of the controller.
